(19) United States
(12) Patent Application Publication
(10) Pub. No.: US 2009/0252977 A1
(43) Pub. Date: Oct. 8, 2009

(54) MULTILAYER FILM REFLECTOR

(75) Inventors: Seiken Matsumoto, Utsunomiya-shi (JP); Kenji Ando, Utsunomiya-shi (JP); Hidehiro Kanazawa, Tokyo (JP); Koji Teranishi, Utsunomiya-shi (JP); Takayuki Miura, Haga-gun (JP); Kyoko Nagata, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/416,544

(22) Filed: Apr. 1, 2009

(30) Foreign Application Priority Data
Apr. 7, 2008 (JP) 2008-098914 (PAT.

(51) Int. Cl. B32B 15/04

(52) U.S. Cl. 428/450

(57) ABSTRACT

A stress distribution resulting from variation in in-plane film quality of a stress relaxation layer and a reflective layer is eliminated. A reflective layer is stacked on a substrate via a stress relaxation layer. The stress relaxation layer has a stress relaxation portion having a uniform film thickness distribution to cancel the internal stress of the reflective layer, and a stress distribution eliminating portion with a film thickness distribution approximated to a second order even function. The stress is substantially proportional to the film thickness. Thus, formation of a given film thickness distribution allows the stress distribution to be controlled. However, changing the film thickness distribution based on a design value may degrade the optical characteristics. Thus, the film thickness distribution of the stress distribution eliminating portion, which serves to eliminate the stress distribution, is approximated to the second order even function. This enables aberration associated with the film thickness distribution to be reduced by adjusting an optical system.

### BACKGROUND OF THE INVENTION

1. Field of the Invention

The present invention relates to a multilayer film reflector used in an exposure apparatus for a soft X ray region.

2. Description of the Related Art

In recent years, with the progress of miniaturization of semiconductor integrated circuit elements, lithography technologies have been developed which use, instead of conventional ultraviolet rays, an EUV (Extreme UltraViolet) region of soft X rays (wavelength: about 11 to 14 nm) having a shorter wavelength than the ultraviolet rays. An optical material conventionally used for light in this wavelength region has a refractive index very close to 1 and significantly absorbs the light. This in principle prevents the utilization of a refractive optical system using lenses. For the above reason, a reflective optical system using a mirror is employed for EUV lithography. The mirror is formed of a multilayer film including two types of substances stacked in alternate layers and having significantly different refractive indices. Examples of the constituent material of the multilayer film commonly used for EUV lithography include Mo and Si.

The multilayer film mirror is formed of a multilayer film with about 40 to 60 periods each corresponding to a wavelength of about 7 nm, which is about half of a wavelength of 13.5 nm commonly used for EUV. Each period is formed by stacking Mo and Si. Such a periodic structure meets conditions for Bragg reflection and superimposes a large number of faint rays of light reflected by respective interfaces on one another at the same phase. Thus, the periodic structure as a whole can offer a high reflectance. The reflectance of the multilayer film mirror formed by this method is higher than 70% at maximum.

Meanwhile, such a multilayer film has generally been known to have internal stress (stress). Thus, a stress generated in the multilayer film deforms a substrate on which the multilayer film is stacked. The resulting shape of the multilayer film mirror may deviate from the originally desired shape. This may disadvantageously degrade a wave aberration that is a performance indicator for an optical system for an exposure apparatus.

Thus, in order to reduce the stress of the multilayer film, various countermeasures have been attempted. For example, a method is known which varies the concentration of B (boron), C (carbon), or P (phosphorous) doped in Si to reduce the stress of the multilayer film (U.S. Pat. No. 6,160,867). Another method has been proposed which forms, between the substrate and the multilayer film, a buffer layer called a stress relaxation layer and having a stress opposing the stress of the multilayer film, thereby canceling the stress (Japanese Patent Application Laid-Open No. 2002-504715).

However, although these technologies are effective for reducing the stress of the multilayer film, uniformly eliminating the stress entirely over the in-plane region (from the center to end of the mirror) of the multilayer film mirror is difficult. This is because the stress value varies within the plane of the multilayer film mirror (stress distribution).

For example, even when an attempt is made to cancel the stress using the stress relaxation layer, the stress is not uniformly eliminated in the mirror plane after the canceling. This is because the stress distribution of a reflective layer that is the multilayer film the stress of which is to be cancelled does not necessarily match the stress distribution of the stress relaxation layer. The stress distribution is considered to result from a difference in film quality in the mirror plane.

In general, IBS (Ion Beam Sputtering), MSP (Magnetron Sputtering), or evaporation is used for a deposition apparatus. However, all these technologies involve a wide deposition range. A mask may be used to limit the deposition range in order to obtain uniform film quality, but this technique has its limit. Furthermore, the mirror shape may include sharp unevenness. In this case, it is impossible that deposition particles travel to the substrate at the same angle while maintaining the same energy in the mirror plane. Thus, the film quality such as density or bonding state may vary in some parts of the mirror plane. Controlling the distribution of the film quality is very difficult. Thus, obviously, controlling the stress distribution is also difficult.

The stress distribution increases the deformation of the substrate for the multilayer film, and the possible deformation is difficult to predict. This results in degrading the wave aberration.

The internal stress of the multilayer film can be reduced by a certain amount by the method of reducing the stress or the method of canceling the stress using the stress relaxation layer, such as described in U.S. Pat. No. 6,160,867 and Japanese Patent Application Laid-Open No. 2002-504715, respectively. However, the presence of the stress distribution prevents the internal stress from being reduced to zero.

A method of inhibiting the stress distribution, which cannot be controlled in connection with the deposition, is to distribute (vary) the film thickness within the mirror plane. The stress increases and decreases consistently with the increase and decrease of the film thickness. Thus, the ability to control the film thickness distribution in the mirror plane enables the stress distribution to be controlled.

The film thickness distribution can be controlled simply by varying, in the mirror plane, the time for which deposition particles are emitted in the deposition apparatus. However, changing the film thickness from a design value in order to eliminate the stress distribution results in a deviation from the designed film thickness distribution. This obviously degrades the wave aberration.

It is, therefore, an object of the present invention to provide a multilayer film reflector that allows a reduction in stress distribution without degrading the wave aberration.

### SUMMARY OF THE INVENTION

The multilayer film reflector in accordance with the present invention includes a substrate having a stress relaxation layer with a multilayer film configuration and a reflective layer stacked thereon, wherein the stress relaxation layer generates a stress acting in a direction opposite to that of a stress generated in the reflective layer, and has a film thickness distribution corresponding to a second order even function, with respect to a radial direction of an optical axis of the multilayer film reflector.

The present invention approximates the film thickness distribution of the stress relaxation layer for controlling a stress distribution, to the second order even function, or applies a film thickness distribution approximated to a second order even function. This enables the stress distribution to be minimized without degrading the wave aberration associated with the film thickness distribution.

This is because the influence on the wave aberration of the film thickness distribution, which can be approximated to the second order even function, can be eliminated by adjusting an optical system constituting an exposure apparatus. That is, provided that a deviation of the film thickness distribution from a design value can be approximated to the second order even function, the degradation of the wave aberration can be avoided.

Further features of the present invention will become apparent from the following description of exemplary embodiments with reference to the attached drawings.

### BRIEF DESCRIPTION OF THE DRAWINGS

FIGS. 1A and 1B are diagrams illustrating the film configuration and stress distribution of a multilayer film reflector in Example 1.

FIG. 2 is a schematic diagram illustrating a sputtering deposition apparatus used in Example 1.

FIG. 3 is a schematic diagram (plan view and sectional view) illustrating a model substrate for sample evaluation.

FIG. 4 is a flowchart illustrating a procedure of designing a multilayer film reflector in Example 1.

FIG. 5 is a graphical representation illustrating the stress distribution of the multilayer film reflector in Example 1 obtained before and after the stress distribution is eliminated.

FIG. 6 is a graphical representation illustrating the film thickness distributions of the multilayer film reflector in Example 1, in which one is a desired (target) film thickness distribution created so as to approximate a second order even function in order to eliminate the stress distribution, and the other is a film thickness distribution of a film actually deposited so as to achieve the desired film thickness distribution.

FIG. 7 is a diagram illustrating the film configuration of a multilayer film reflector according to Example 2.

FIG. 8 is a graphical representation illustrating the stress distribution of the multilayer film reflector in Example 2 obtained before and after the stress distribution is eliminated.

FIG. 9 is a graphical representation illustrating the film thickness distributions of the multilayer film reflector according to Example 2, in which one is a desired film thickness distribution created so as to approximate a second order even function in order to eliminate the stress distribution, and the other is a desired film thickness distribution of a film actually deposited so as to achieve the desired film thickness distribution.

FIG. 10 is a diagram illustrating the film configuration of a multilayer film reflector in Example 3.

FIG. 11 is a graphical representation illustrating the stress distribution of the multilayer film reflector in Example 3 obtained before and after the stress distribution is eliminated.

FIG. 12 is a graphical representation illustrating the film thickness distributions of the multilayer film reflector according to Example 3, in which one is a desired film thickness distribution created so as to approximate a second order even function in order to eliminate the stress distribution, and the other is a film thickness distribution of a film actually deposited so as to achieve the target film thickness distribution.

FIG. 13 is a diagram illustrating a reflective reduction projection optical system for a reflective reduction projection exposure apparatus.

### DESCRIPTION OF THE EMBODIMENTS

An exemplary embodiment for carrying out the present invention will be described with reference to the accompanying drawings.

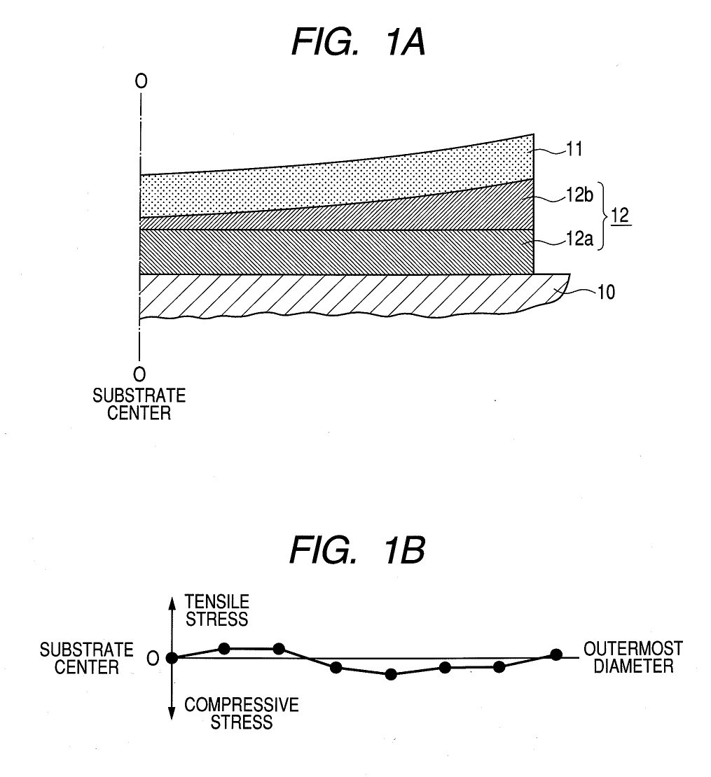

FIGS. 1A and 1B illustrate the film configuration and stress distribution of a multilayer film reflector with a multilayer film configuration in accordance with the exemplary embodiment.

The multilayer film reflector is configured to be rotationally symmetric with respect to an optical axis.

The multilayer film reflector has a stack configuration in which a reflective layer 11 and a stress relaxation layer 12 are stacked; the reflective layer 11 and the stress relaxation layer 12 are formed to be rotationally symmetric with respect to the optical axis. The shape of the substrate is not limited to a flat one. The substrate may have a recessed or protruding surface. Furthermore, the surface of the film may not be parallel to the surface of the substrate and may be inclined with respect to the surface of the substrate. The shape of the multilayer film reflector, including the substrate is not limited to a disk shape but may be like a donut or fan shape.

The stress relaxation layer 12 has a film thickness distribution approximated to a second order even function with respect to the radial direction of the optical axis. The stress relaxation layer 12 generates a stress acting in a direction opposite to that of an internal stress (stress) generated in the reflective layer 11. For example, if the reflective layer 11 generates a tensile stress, the stress relaxation layer 12 is designed to generate a compressive stress.

The reflective layer 11 is formed of alternate layers of Mo and Si, and generally has a constant film thickness over its entirety. The reflective layer 11 has a distributed Bragg reflection structure similar to the structure of a quarter wavelength stack, and also has a multilayer film reflection configuration such that a peak wavelength is 13.5 nm at an incident angle of 0°. The multilayer film reflector is formed to be rotationally symmetric with respect to the optical axis. The film thickness distribution in the radial direction of the optical axis is even at a peak wavelength of 13.5 nm. However, depending on the optical design, the film thickness distribution may be uniform or non-uniform to provide an incline film at a peak wavelength other than 13.5 nm.

The stress relaxation layer 12 includes a stress relaxation portion 12a with a uniform film thickness distribution and a stress distribution eliminating portion 12b. The stress relaxation portion 12a is a multilayer film interposed between the substrate 10 and the reflective layer 11 so as to cancel the internal stress of the reflective layer 11. However, when the stress relaxation portion 12a is formed to have a uniform film thickness as with the reflective layer, the stress distribution resulting from variation in the film quality of the reflective layer 11 cannot be eliminated. Thus, the stress distribution eliminating layer 12b is provided to approximate the film thickness distribution to the second order even function to eliminate the stress distribution. At this time, the stress distribution eliminating layer 12b does not need to be a multilayer film, unlike the stress relaxation portion 12a, and may be formed of, for example, a single layer made of only Si. The use of such a single layer can simplify the film formation steps.

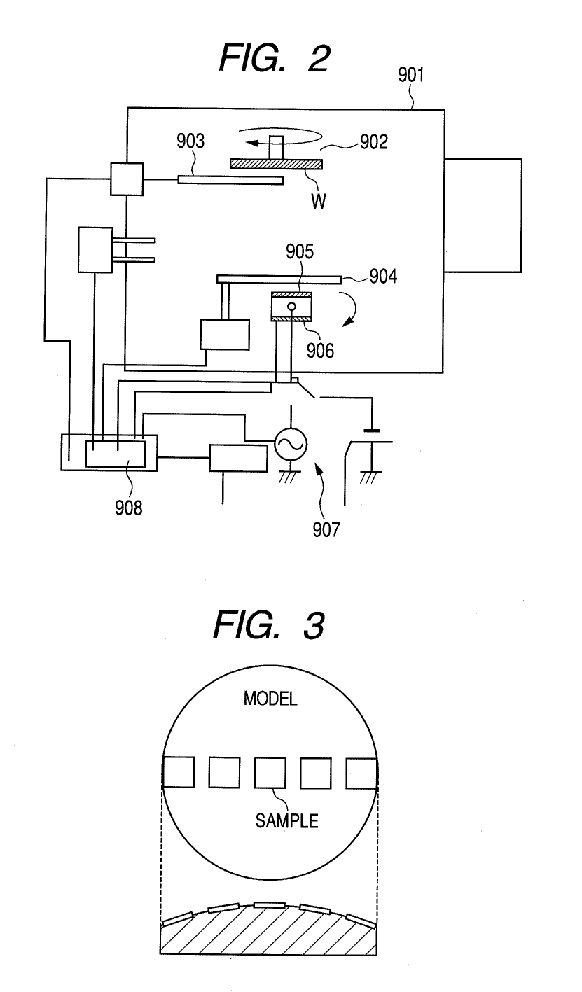

FIG. 2 is a schematic diagram illustrating a sputtering deposition apparatus used in the present example. All control systems in the apparatus are connected to a computer 908 and can be controlled at a time. A multilayer film of Si and Mo is deposited, via a mask 903, on a substrate W held in a vacuum chamber 901 by a substrate holder 902.

A B-doped polycrystalline Si target 905 of diameter 4 inches and a metal Mo target 906 are attached to a target apparatus. The targets are rotated to switch the materials so that the proper material is deposited on the substrate W. The materials of the targets may be replaced with different ones.

The substrate W is made of silicon of a diameter 500 mm and a thickness 300 mm and rotates during deposition.

A shutter 904 and a movable mask 903 controlling the film thickness distribution on the substrate are located between the substrate W and the targets. The mask 903 includes an opening smaller than the deposition area on the substrate W. During deposition, the mask 903 and the substrate W are moved relative to each other, with the relative movement speeds of the mask 903 and substrate W controlled. Then, a reflection film or a stress relaxation layer can be formed which has a film thickness distribution on the substrate. However, the deposition method is not limited to this aspect. During the deposition, 30 sccm of Ar gas is introduced as a process gas. A RF high frequency power of 150 W is fed to the target at MHz by an RF power source 907. The film thickness of each of the layers is temporally controlled by the computer 908.

Sputtering is used as the deposition method. However, the manufacturing method is not limited to this aspect. For example, an evaporation method may be used to form a similar film. Furthermore, the deposition materials are not limited to Si and Mo. Ru, C, or B4C may also be used depending on the purpose.

To evaluate the film thickness distribution and the stress distribution, first, as shown in FIG. 3, a model (model substrate) is produced which has the same shape as a desired mirror substrate to which small sample substrates (here, Si or SiO₂) can be stuck along the shape of the model. The samples have respective film parameters for corresponding radial positions on the mirror substrate shape. Thus, a step of evaluating the film thickness and stress determined at each radial position is repeated to allow the stress distribution of the multilayer film reflector to be eliminated. As illustrated in FIG. 1B, the resultant stress distribution is very insignificant.

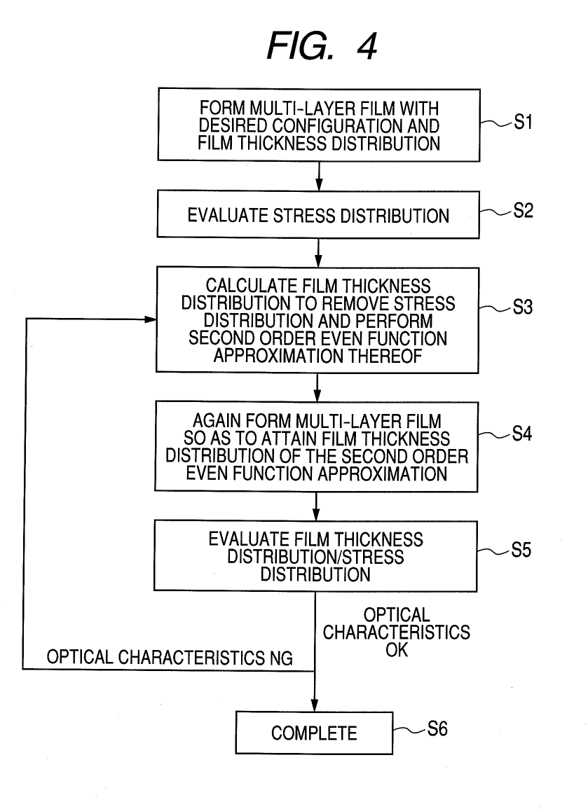

FIG. 4 illustrates a procedure carried out until a multilayer film reflector satisfying optical characteristics is produced. In step S1, a multilayer film reflector of a multilayer configuration having desired reflection characteristics is produced. In step S2, the stress distribution is evaluated. In step S3, the film thickness distribution of the stress distribution eliminating layer required to eliminate the stress distribution is calculated and approximated to a second order even function. A multilayer film reflector with the stress distribution eliminating layer having the resulting film thickness distribution is then produced (step S4). The stress distribution is evaluated again (step S5). Steps S3 to S5 are repeated until the optical characteristics are satisfied.

The second order even function is defined as follows. For optical design, the film thickness distribution can be preferably provided in the form of a certain function. An EUV projection optical system is a coaxial system in which all mirrors have a common axis called an optical axis with respect to which the mirrors are rotationally symmetric. Here, the distance from the optical axis is defined as r. Then, when the film thickness distribution is expressed in the form of an even function ƒf(r)=a+br²+cr⁴ . . . , the rotational symmetry of the original optical system with respect to the optical axis can be conveniently preserved. Thus, the term “even function” as used herein is defined based on this idea about the optical axis.

The term “radial direction” herein employed is not defined with respect to a direction from the center of the substrate but defined with the optical axis of the optical system being set as an origin and serves to express the film thickness distribution. When expressed by an even function, particularly, a low-order function such as a second order function, the film thickness distribution does not substantially degrade the wave aberration. The results of studies carried out by the present inventors indicate that in an optical system constituted of a plurality of rotationally symmetric reflectors, when the substrate shape is deformed along the second order even function, the resulting wave aberration is a focus component. The focus component can be eliminated by adjusting the mirrors in the back and forth direction. The present invention is based on this idea. Furthermore, the second order even function includes a lower order component such as a fourth order and a sixth order. Moreover, in the present invention, a film thickness distribution obtained by applying a film thickness distribution of a second order even function component to a original flat or inclined film thickness distribution is deemed to be a film thickness distribution approximated to a second order even function. The reason is that the film thickness distribution state in which the stress distribution is finally eliminated is not necessarily be constituted of a film thickness distribution of only a second order even function, depending on the original film thickness distribution.

On the other hand, the degree to which the film thickness distribution is approximated to the even function is defined as follows. A film thickness distribution curve expressed in percentage is obtained by dividing the entire in-plane film thickness by the film thickness at the innermost diameter. A second order even function curve also expressed in percentage is obtained by approximating the film thickness distribution to the second order even function. The absolute value of the difference between the film thickness distribution curve and the second order even function curve is set to at most 0.1%. The as-determined difference corresponds to a film thickness error associated with the optical characteristics. Thus, to prevent the optical characteristics from being affected, the absolute value is set to at most 0.1%.

In a common deposition apparatus, the film quality, which may vary stress, varies in a fixed direction from the center to periphery of the film. Thus, provided that secondary components can be eliminated, such a stress distribution as affects the optical characteristics can be eliminated.

Incidentally, either the entire stress relaxation layer or the reflective layer may have the film thickness distribution approximated to the second order even function.

### Example 1

The difference in stress distribution between a conventional multilayer film reflector and the multilayer film reflector according to the present invention will be described below. The difference will be similarly described in the other examples.

First, a conventional multilayer film reflector constituted of a stress relaxation layer and a reflective layer will be described as a comparative example. In the multilayer film reflector, 40 alternate layers of Si and Mo were stacked to form a reflective layer. To reduce the stress of the reflective layer, 18 alternate layers of Si and Mo were stacked to film thicknesses different from those in the reflective layer under disposition conditions different from those for the reflective layer. The stress relaxation layer (stress relaxation portion) was thus deposited in advance under the reflective layer. The film thickness and deposition time were 4.22 nm/42 seconds for Si in the reflective layer, 2.68 nm/13 seconds for Mo in the reflective layer, 9 nm/178 seconds for Si in the stress relaxation layer, and 1 nm/10 seconds for Mo in the stress relaxation layer. Deposition time data was input to the computer. The deposition and the film thickness evaluation were repeated. Thus, the film thicknesses were set to allow the desired film thickness distribution to be obtained, in this case, to achieve a uniform in-plane thickness (film thickness distribution error: at most ±0.1%).

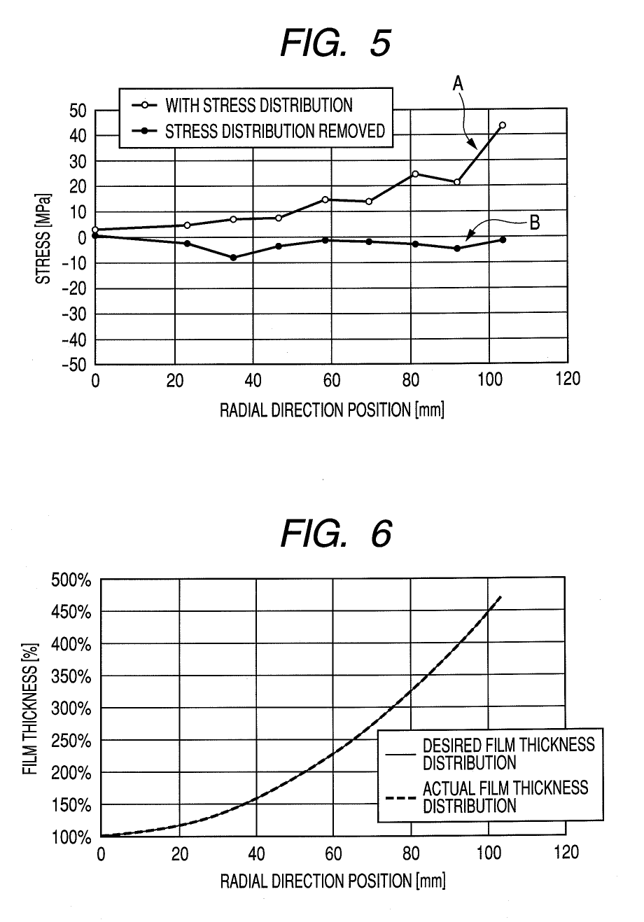

Stress values obtained at respective radial positions in the conventional multilayer film reflector were evaluated to calculate a stress distribution. As illustrated in sequential line A in FIG. 5, the tensile stress increased outward in the radial direction, and a stress distribution exceeding ±20 MPa was obtained.

Now, the multilayer film reflector in the present example, illustrated in FIGS. 1A and 1B (the deposition conditions are the same as those described above) will be described. To eliminate the above-described stress distribution, the film thickness distribution of the stress distribution eliminating portion 12b, constituted of a single Si layer, was calculated and approximated to a second order even function. A film thickness distribution curve was then calculated as illustrated in FIG. 6. In this case, the stress distribution is such that the tensile stress increases outward in the radial direction. Thus, the film thickness of Si, having compressive stress, needs to be increased outward in the radial direction.

The stress distribution eliminating portion was deposited after the deposition of the stress relaxation portion. A reflective layer was then deposited on the stress distribution eliminating portion to obtain a stack configuration of the stress relaxation layer and the reflective layer as illustrated in FIGS. 1A and 1B. In this case, the film thickness distribution of the stress distribution eliminating portion 12b approximated to the second order even function cannot be formed as intended only by one deposition. Thus, as illustrated in the flowchart in FIG. 4, the film thickness distribution needs to be adjusted so as to approximate the desired second order even function. The result is illustrated in FIG. 6 as an actual film thickness distribution. The difference from the desired film thickness distribution approximated to the second order even function, that is, the film thickness distribution error, was at most ±0.1%. Furthermore, the stress distribution was evaluated to be ±5 MPa as illustrated in sequential line B in FIG. 5. That is, the stress distribution was successfully reduced to at most 10 MPa.

Here, if the stress distribution involves one direction and has failed to decrease to the desired value, the film thickness distribution approximated to the second order even function may be created again and the same procedure may be repeated, as illustrated in the flowchart in FIG. 4.

In the present example, the stress distribution eliminating portion 12b was made of Si. However, the stress distribution eliminating portion 12b may be made of Mo or a Mo/Si multilayer film. With Mo, which tends to have a tensile stress, the film thickness may decrease outward in the radial direction.

### Example 2

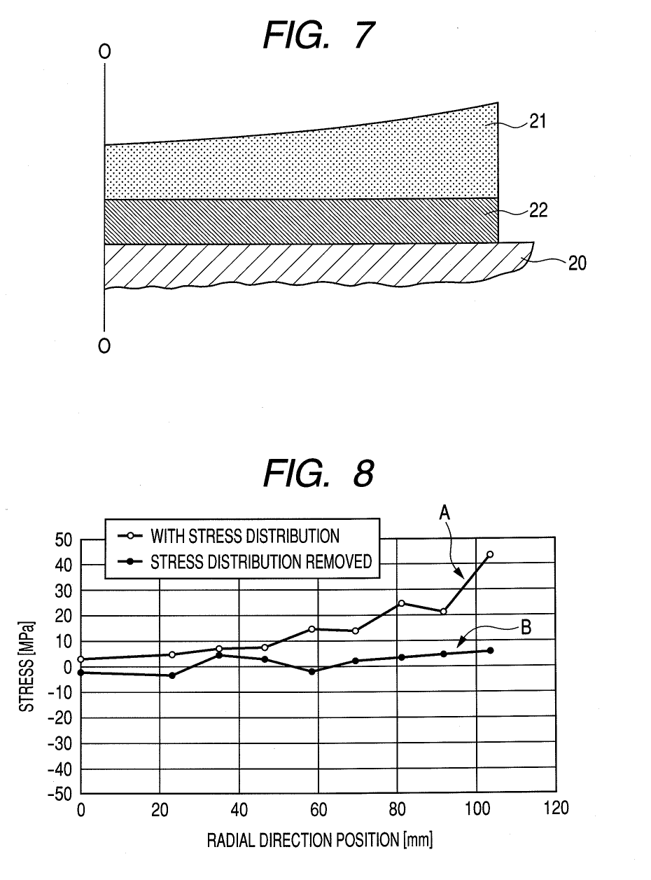

FIG. 7 illustrates the film configuration of a multilayer film reflector in accordance with Example 2. The multilayer film reflector has a substrate 20, a stress relaxation layer 22, and a reflective layer 21 of Mo and Si having desired reflection characteristics; the stress relaxation layer 22 and the reflective layer 21 are stacked on the substrate 20. To allow elimination of a stress distribution that cannot be reduced by the stress relaxation layer 22, the film thickness ratio of Si and Mo in the reflective layer 21 is changed. Furthermore, the film thickness distribution of the reflective layer 21 is approximated to a second order even function.

A multilayer film reflector constituted of a stress relaxation layer and a reflective layer as a conventional example in the present example is the same as that described in Example 1.

Now, the multilayer film reflector in the present example illustrated in FIG. 7 will be described.

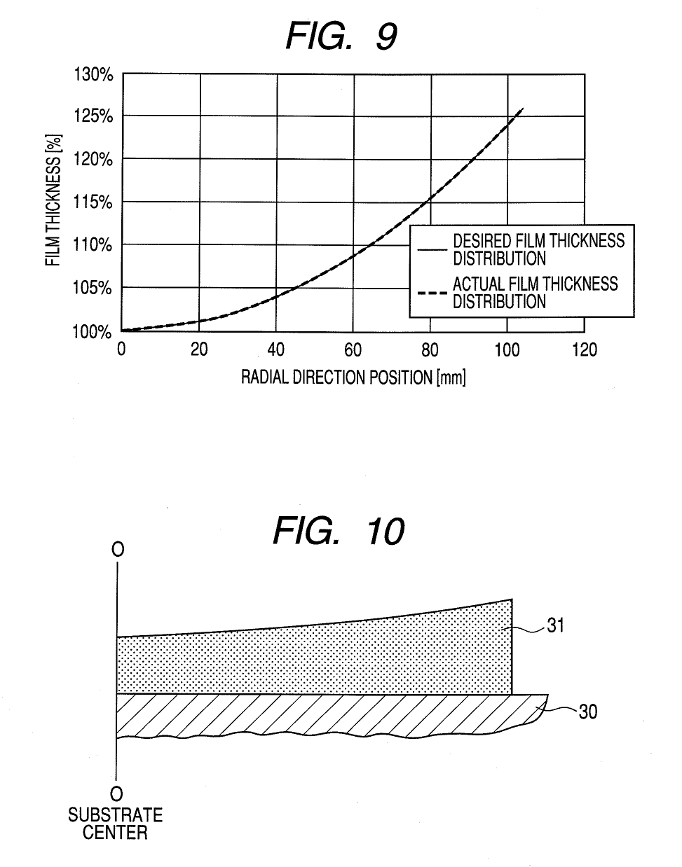

In the present example, to eliminate the stress distribution, the film thickness distribution of the reflective layer is changed. Here, the stress distribution is such that the tensile stress increases outward in the radial direction. Accordingly, the film thickness of the reflective layer, having a compressive stress, needs to be increased outward in the radial direction. Thus, the film thickness distribution of the reflective layer was calculated in the direction in which the stress distribution is to be eliminated. The calculated film thickness distribution was then approximated to a second order even function. That is, the desired film thickness distribution curve was calculated as illustrated in FIG. 9.

After the stress relaxation layer was deposited, the reflective layer with the film thickness distribution approximated to the second order even function was deposited. Thus, such a film configuration as illustrated in FIG. 7 was obtained. In this case, the film thickness distribution of the reflective layer was adjusted once so as to obtain a uniform film. However, since the film thickness distribution was changed, the deposition was repeated again so as to adjust the film thickness distribution to the one approximated to the desired second order even function. The film thickness distribution of the reflective layer is illustrated in FIG. 9 as an actual film thickness distribution. The difference from the desired film thickness distribution approximated to the second order even function, that is, the film thickness distribution error, was at most ±0.1%. Furthermore, the stress distribution was evaluated to be ±5 MPa as illustrated in sequential line B in FIG. 8. That is, the stress distribution was successfully reduced to at most 10 MPa.

Here, if the stress distribution involves one direction and has failed to decrease to the desired value, a film thickness distribution approximated to the second order even function may be created again and the same procedure may be repeated, as illustrated in the flowchart in FIG. 4.

Moreover, the film thickness distribution approximated to the second order even function may be applied to, instead of the reflective layer, both the reflective layer and a stress relaxation layer, or a combination of the reflective layer and the Mo in the stress relaxation layer.

### Example 3

FIG. 10 illustrates a multilayer film reflector in accordance with Example 3. The multilayer film reflector has, on a substrate 30, and a reflective layer 31 in which Mo and Si have a film thickness ratio approximated to a second order even function so as to relax a stress.

First, a conventional multilayer film reflector constituted of a reflective layer will be described as a comparative example. Forty alternate layers of Si and Mo having the desired reflection characteristics of the multilayer film reflector were stacked so as to form films for a reflective layer. The film thickness and deposition time were 4.22 nm/63 seconds for Si in the reflective layer, and 2.68 nm/30 seconds for Mo in the reflective layer. Deposition time data was input to the computer. The deposition and the film thickness evaluation were repeated. Thus, the film thicknesses were set to allow the desired film thickness distribution to be obtained, in this case, to achieve a uniform in-plane thickness (film thickness distribution error: at most ±0.1%).

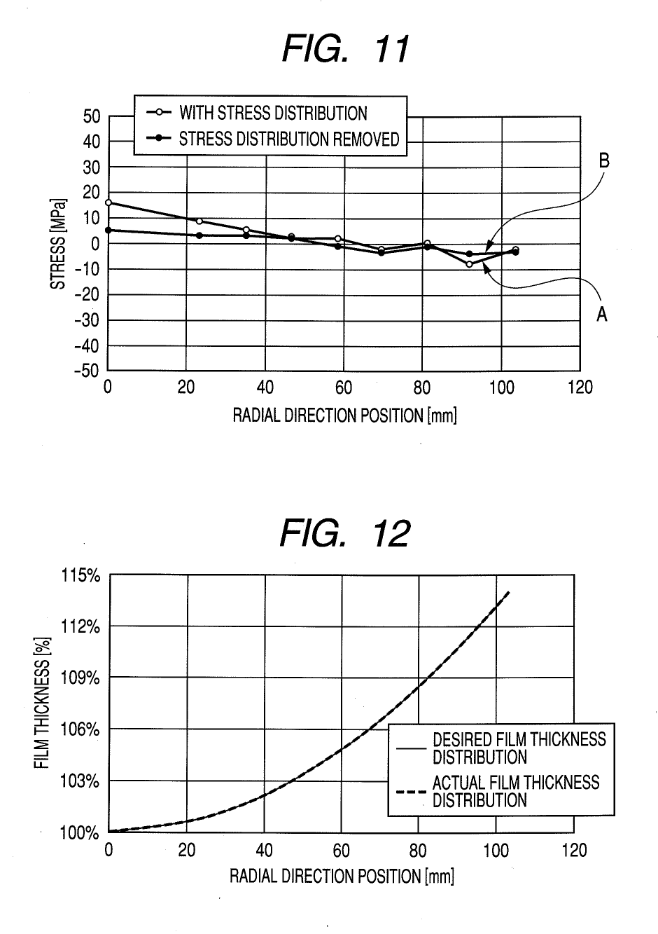

Stress values obtained at respective radial positions in the reflective layer for which the film thickness distribution was adjusted were evaluated to calculate a stress distribution as illustrated in sequential line A in FIG. 11. The tensile stress increased inward in the radial direction, and a stress distribution exceeding ±10 MPa was obtained.

Now, the multilayer film reflector in accordance with the present example will be described. To eliminate the stress distribution, the film thickness distribution of the reflective layer is changed. Here, the stress distribution is such that the tensile stress increases inward in the radial direction. The reflective layer has a stress at the inner portion in the radial direction and has no substantial stress at the outer portion in the radial direction. Accordingly, when the film thickness of the Si reflective layer having a compressive stress is decreased inward and is increased outward in the radial direction, the tensile stress at the inner portion in the radial direction can be reduced although cannot be completely eliminated. Thus, the film thickness distribution of the reflective layer was calculated in the direction in which the stress distribution was to be eliminated. The calculated film thickness distribution was then approximated to a second order even function. That is, the desired (target) film thickness distribution curve was calculated as illustrated in FIG. 12.

The reflective layer with the film thickness distribution approximated to the second order even function was deposited. Thus, such a film configuration as illustrated in FIG. 10 was obtained. In this case, the film thickness distribution of the reflective layer was adjusted once so as to obtain a uniform film. However, since the film thickness distribution was changed, the deposition was repeated again so as to adjust the film thickness distribution to the one approximated to the desired second order even function. The resulting film thickness distribution of the Si layer is illustrated in FIG. 12. The difference from the desired film thickness distribution approximated to the second order even function, that is, the film thickness distribution error, was at most ±0.1%. Furthermore, the stress distribution was evaluated to be ±5 MPa as illustrated in sequential line B in FIG. 11. That is, the stress distribution was successfully reduced to at most 10 MPa.

Here, if the stress distribution involves one direction and has failed to decrease to the desired value, the film thickness distribution approximated to the second order even function may be created again and the same procedure may be repeated, as illustrated in the flowchart in FIG. 4.

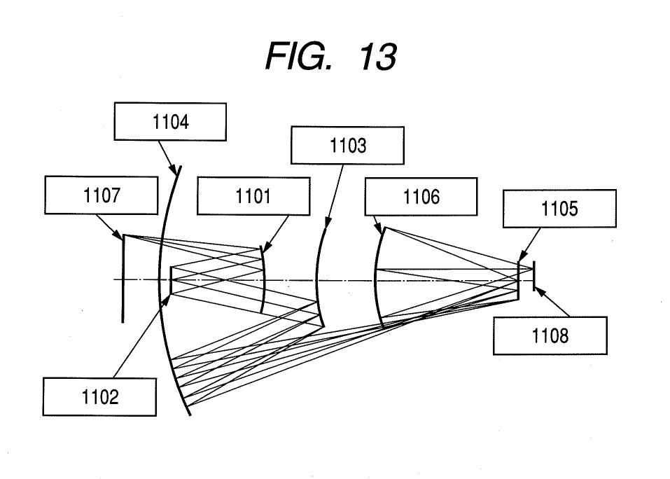

FIG. 13 illustrates a reflective reduction projection optical system in a reflective reduction projection exposure apparatus using the reflector produced in Examples 1 to 3. As a light source, 13.5-nm EUV light was used. A pattern formed on a reflective mask 1107 was transferred to a resist on a substrate 1108 via the reflective reduction projection optical system including reflective layers 1101, 1102, 1103, 1104, 1105, and 1106. Then, for example, a resist pattern of size 0.025 μm was accurately obtained from a 0.1-μm pattern on the mask.

In the apparatus illustrated in FIG. 13, all the reflectors involve stringent requirements. Thus, any of Examples 1 to 3, exhibiting excellent optical characteristics, was used as each of the reflectors.

Sputtering was used as a deposition method. However, the manufacturing method is not limited to this aspect. Similar films can be formed using, for example, an evaporation method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-098914, filed Apr. 7, 2008, which is hereby incorporated by reference herein in its entirety.

What is claimed is:

1. A multilayer film reflector comprising:
a substrate;
a stress relaxation layer formed on the substrate; and
a reflective layer formed on the stress relaxation layer and comprising a multilayer film,
wherein the stress relaxation layer generates a stress acting in a direction opposite to that of a stress generated in the reflective layer, and has a film thickness distribution corresponding to a second order even function, with respect to a radial direction of an optical axis of the multilayer film reflector.

2. The multilayer film reflector according to claim 1, wherein the stress relaxation layer comprises:
a stress relaxation portion; and
a stress distribution eliminating portion with a film thickness distribution corresponding to a second order even function, with respect to the radial direction.

3. A multilayer film reflector comprising:
a substrate; and
a reflective layer formed on the substrate and comprising a multilayer film,
wherein the reflective layer has a film thickness distribution corresponding to a second order even function, with respect to a radial direction of an optical axis of the multilayer film reflector.

4. The multilayer film reflector according to claim 3, further comprising:
a stress relaxation layer formed between the substrate and the reflective layer,
wherein the stress relaxation layer generates a stress acting in a direction opposite to that of a stress generated in the reflective layer.
